(19) United States
(12) Patent Application Publication
(10) Pub. No.: US 2012/0262894 A1
(43) Pub. Date: Oct. 18, 2012

(54) DEVICE FOR SECURING A MODULE UNIT TO A SUPPORT RAIL

(75) Inventor: Joerg Soefker, Lemgo (DE)

(73) Assignee: PHOENIX CONTACT GMBH & CO. KG, Blomberg (DE)

(21) Appl. No.: 13/516,771

(22) PCT Filed: Nov. 4, 2010
(86) PCT No.: PCT/EP2010/006715

§ 371 Date: Jun. 18, 2012

(30) Foreign Application Priority Data
Dec. 17, 2009 (DE) 10 2009 059 014.5

(51) Int. Cl. H02B 1/052

(52) U.S. Cl. 361/759

(57) ABSTRACT

A device for securing a module unit to a support rail, the module unit including a receiving element configured to receive at least one circuit board and lateral elements configured to lock the receiving element, includes a securing unit having a longitudinal direction that is configured to slide onto the module unit in the longitudinal direction so as to connect the module unit to the support rail.

### CROSS REFERENCE TO RELATED APPLICATIONS

This application is a U.S. National Phase application under 35 U.S.C. §371 of International Application No. PCT/EP2010/006715, filed on Nov. 4, 2010, and claims benefit to German Patent Application No. DE 10 2009 059 014.5, filed on Dec. 17, 2009. The International Application was published in German on Jul. 14, 2011 as WO 2011/082725 A1 under PCT Article 21 (2).

### FIELD

The invention relates to a device for securing a module unit, comprising a receiving element for receiving one or more circuit boards and comprising lateral elements which lock the receiving element, to a support rail by means of a securing unit.

### BACKGROUND

A module unit of this type conventionally comprises a receiving element, which may be configured in the form of a bowl-shaped support element, inside which one or more circuit boards can be inserted into mounting elements which are provided on the receiving element. For locking the receiving element to a module unit, generally two lateral elements are provided on the receiving element, and are secured to the receiving element and to the two mounting elements of the receiving element. In the module units which are known thus far, it is provided that foot elements, via which the module unit can be secured to a support rail, are formed on the lateral elements. A drawback in this instance is that undesired flexion of the module unit, in particular of the receiving element and the circuit boards which are arranged therein, may rapidly occur, in particular in relatively long module units.

### SUMMARY

In an embodiment, the present invention provides a device for securing a module unit to a support rail. The module unit includes a receiving element configured to receive at least one circuit board and lateral elements configured to lock the receiving element. The device includes a securing unit having a longitudinal direction that is configured to slide onto the module unit in the longitudinal direction so as to connect the module unit to the support rail.

### BRIEF DESCRIPTION OF THE DRAWINGS

Exemplary embodiments of the present invention are described in more detail below, with reference to the appended drawings, in which:

FIG. 1 is a schematic drawing of a module unit which is secured to a support rail by means of a securing unit according to the invention;

FIG. 2 is a schematic drawing of the securing unit shown in FIG. 1 when it is mounted on the support rail; and

FIG. 3 is a further schematic drawing of the securing unit shown in FIG. 1 when it is mounted on the support rail.

### DETAILED DESCRIPTION

In an embodiment the present invention provides a device for securing a module unit to a support rail by means of which the stability of the module unit can be improved in a simple manner.

In an embodiment, the device includes a receiving element for receiving one or more circuit boards and comprising lateral elements which lock the receiving element, to a support rail comprises a securing unit. This securing unit can be configured in such a way that the securing unit is configured so as to be able to slide onto the module unit in the longitudinal direction of the securing unit so as to connect the module unit to the support rail.

The securing unit is preferably configured in the form of an elongate profile. The securing unit is distinguished by the fact that it can be secured to a fully assembled module unit at any time, without the module unit having to be disassembled for this purpose. In an embodiment, the securing unit is secured by sliding the securing unit onto the module unit in the longitudinal direction of the securing unit, and as a result, particularly rapid and simple assembly is possible. In this context, the longitudinal direction is the direction along the longitudinal axis of the securing unit, and thus transverse to the direction of extension of the support rail on the module unit when the securing unit is secured to the module unit. The securing unit can thus be retrofitted at any time, and as the device according to the invention is thus distinguished by particularly high flexibility.

In accordance with an embodiment of the invention, the securing unit comprises an undercut, by means of which the securing unit can be slid onto a web element which is formed on the module unit. The web element is preferably configured in a T shape, in such a way that the undercut of the securing unit can be pushed onto the web element. Providing an undercut on the securing unit makes it possible to secure the securing unit without the need to provide additional securing elements on the module unit. In this context, the web element is preferably arranged on the base plate, which faces in the direction of the support rail, of the receiving element of the module unit. So as to achieve higher stability of the connection between the securing unit and the module unit, more than one web element and more than one undercut are preferably provided.

In accordance with a further preferred configuration, the securing unit comprises a latching element for securing the securing unit to the support rail. The latching element preferably comprises an arm element, on which a snap-in hook is provided which can snap in behind an edge of the support rail so as to fix the securing unit to the support rail, in such a way that the securing unit can be clamped to the support rail. To release the securing unit, the snap-in hook can be snapped out again, in such a way that the securing unit can be removed from the support rail.

For this purpose, it is preferably provided that the latching element is mounted pivotably on the securing unit. In this context, the latching unit or the arm element of the latching unit is preferably mounted pivotably on the securing unit at the end opposite the snap-in hook, in such a way that the snap-in hook can be pivoted out of the attachment to the support rail by actuating the latching unit. This makes it possible to mount the securing unit on the support rail in a particularly simple and rapid manner.

For actuating the latching element, it is preferably provided that the latching element comprises an actuation surface for actuating the latching element. The actuation surface is preferably provided on the end of the latching element or on the end of the arm element of the latching element which is mounted pivotably on the securing unit. The actuation surface is preferably configured in the form of an opening or an indentation, with which a user can engage manually or by means of a tool, for example a screwdriver, so as to produce a pivoting movement of the latching element.

In an embodiment, the invention further relates to a module unit comprising a device, configured and developed as disclosed above, for securing the module unit to a support rail.

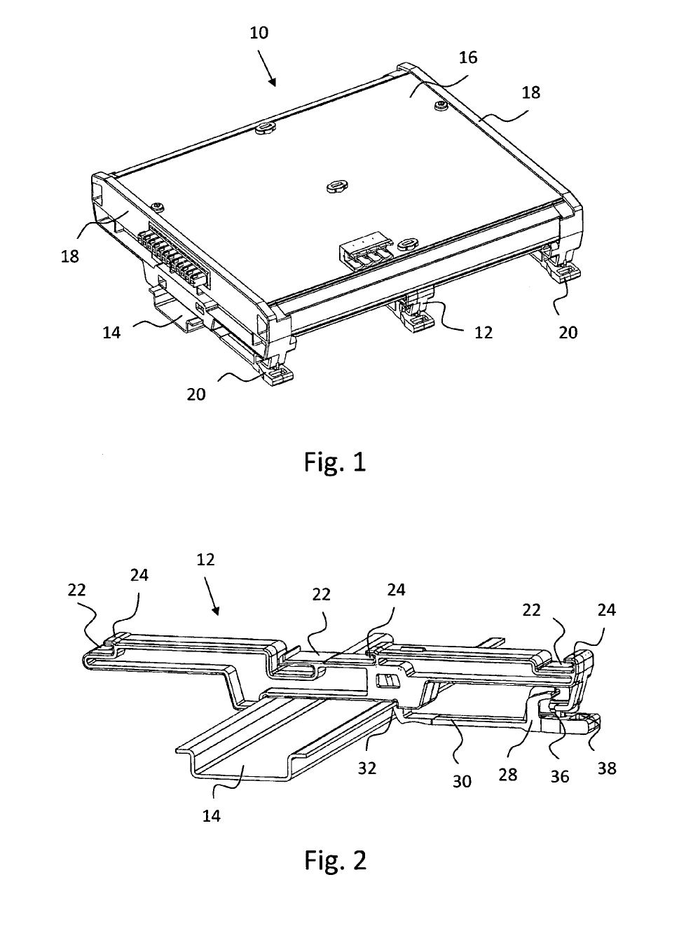

FIG. 1 shows a module unit 10, which is secured to a support rail 14 by means of a securing unit 12. The module unit 10 comprises a receiving element 16, inside which one or more circuit boards are arranged. The receiving element 16 is locked at the two transverse sides thereof, in each case by a lateral element 18. Foot elements 20, by means of which the lateral elements 18 can be secured to the support rail 14, are provided on these lateral elements 18. The securing unit 12 is provided in addition to the foot elements 20 which are arranged on the lateral elements 18, and can be secured directly to the receiving element 16 of the module unit 10.

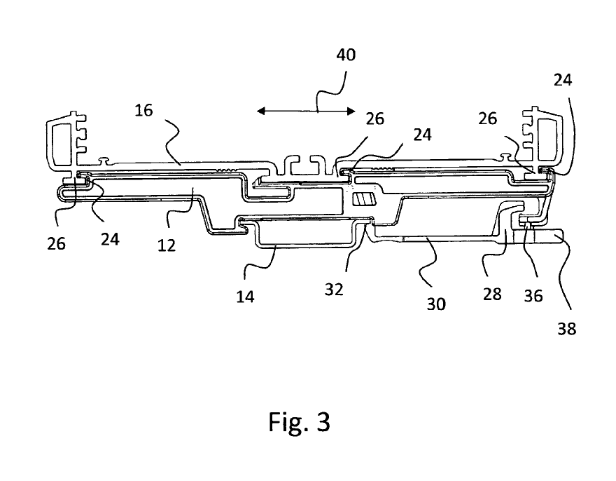

FIG. 2 shows the securing unit 12 according to an embodiment of the invention, secured to a support rail 14. The securing unit 12 comprises three recesses 22, which are each provided with an undercut 24. By means of the recesses 22 and the undercuts 24 which are integrally formed therein, the securing unit can be slid onto web elements 26, which are provided in the receiving element 16 and which are preferably configured in a T shape, as is shown in FIG. 3. The securing unit 12 can be slid onto the web elements 26 or slid off the web elements 26 by displacement in the longitudinal direction thereof, which is represented by the arrow 40. When it is slid on, the securing unit 12 preferably catches in the recess 22 which is provided centrally on the securing unit 12, preferably by means of a snap-in hook which is provided in the recess 22.

For securing the securing unit 12 to the support rail 14, the securing unit 12 comprises a latching element 28. The latching element 28 comprises an arm element 30, on which a snap-in hook 32 is provided which can snap in behind an edge of the support rail 14 so as to fix the securing unit 12 to the support rail 14. To release the securing unit 12, the snap-in hook 32 can be snapped out of the attachment again, in such a way that the securing unit 12 can be removed from the support rail 14.

In this context, the latching element 28 is preferably mounted pivotably on the end 36 of the securing unit 12 opposite the snap-in hook 32, in such a way that the snap-in hook 32 can be pivoted into or out of the attachment to the support rail 14 by actuating the latching unit 28.

For actuating the latching element 28, the latching element comprises an actuation surface 38, which is provided on the end 36 of the latching element 28 which is mounted pivotably on the securing unit 12. The actuation surface 28 is configured in the form of an opening, with which a user can engage by means of a tool, for example a screwdriver, so as to produce a pivoting movement of the latching element 28.

While the invention has been particularly shown and described with reference to preferred embodiments thereof, it will be understood by those skilled in the art that various changes in form and details may be made therein without departing from the spirit and scope of the invention.

### LIST OF REFERENCE NUMERALS

Module unit 10

Securing unit 12

Support rail 14

Receiving element 16

Lateral element 18

Foot element 20

Recess 22

Undercut 24

Web element 26

Latching element 28

Arm element 30

Snap-in hook 32

End 36

Actuation surface 38

Longitudinal direction 40

1-6. (canceled)

7. A device for securing a module unit to a support rail, the module unit including a receiving element configured to receive at least one circuit board and lateral elements configured to lock the receiving element, the device comprising:
a securing unit having a longitudinal direction and configured to slide onto, the module unit in the longitudinal direction so as to connect the module unit to the support rail.

8. The device recited in claim 7, wherein the securing unit includes an undercut configured so as to slide the securing unit onto a web that is formed on the module unit.

9. The device recited in claim 7, further comprising a latching element configured to secure the securing unit to the support rail.

10. The device recited in claim 8, further comprising a latching element configured to secure the securing unit to the support rail.

11. The device recited in claim 9, wherein the latching element is pivotably mounted on the securing unit.

12. The device recited in claim 9, wherein the latching element includes an actuation surface configured to actuate the latching element.

13. A system comprising:
a module unit including a receiving element configured to receive at least one circuit board and lateral elements configured to lock the receiving element; and
a device for securing the module unit to a support rail, the device including a securing unit having a longitudinal direction and configured to slide onto the module unit in the longitudinal direction so as to connect the module unit to the support rail.

14. The system recited in claim 13, wherein the module unit includes a web, and the securing unit includes an undercut configured so as to slide the securing unit onto the web.

15. The system recited in claim 13, wherein the device includes a latching element configured to secure the securing unit to the support rail.

16. The system recited in claim 14, wherein the device includes a latching element configured to secure the securing unit to the support rail.

17. The device recited in claim 15, wherein the latching element is pivotably mounted on the securing unit.

18. The device recited in claim 15, wherein the latching element includes an actuation surface configured to actuate the latching element.
